(19) United States
(12) Patent Application Publication
(10) Pub. No.: US 2013/0159942 A1
(43) Pub. Date: Jun. 20, 2013

(54) INFORMATION PROCESSING DEVICE, INFORMATION PROCESSING METHOD, AND PROGRAM

(71) Applicant: Sony Corporation, Tokyo (JP)

(72) Inventors: Hiroyuki Mizunuma, Tokyo (JP); Tsuyoshi Ishikawa, Kanagawa (JP); Yoshiyuki Mineo, Kanagawa (JP); Yoshihito Ohki, Tokyo (JP)

(73) Assignee: Sony Corporation, Tokyo (JP)

(21) Appl. No.: 13/705,681

(22) Filed: Dec. 5, 2012

(30) Foreign Application Priority Data
Dec. 14, 2011 (JP) 2011-272994

(51) Int. Cl. G06F 3/01

(52) U.S. Cl. CPC G06F 3/017
USPC 715/863

(57) ABSTRACT

An information processing apparatus includes a proximity panel, a communication module and a controller. The proximity panel receives first gesture information. The first gesture information is received in response to a trajectory of movement on the proximity panel. The communication module receives second gesture information from a computing device. The controller determines whether the first gesture information and the second gesture information correspond to predetermined gesture information. In the event that the controller determines that the first gesture information and the second gesture information correspond to the predetermined gesture information, the controller causes predetermined data to be communicated with the computing device.

### RELATED APPLICATIONS

The present disclosure contains subject matter related to that disclosed in Japanese Priority Patent Application JP 2011-272994 filed in the Japan Patent Office on Dec. 14, 2011, the entire contents of which are hereby incorporated by reference.

### FIELD

The present technology relates to an information processing device, an information processing method, and a program, and particularly to an information processing device, an information processing method, and a program which enable communication and authentication of a communication partner with a simple operation.

### BACKGROUND

In recent years, many electronic devices such as tablet-type computers, and the like that are appropriate for carrying around have been developed, and most of the devices are designed to execute various processes by performing communication with other computers, and the like.

For such electronic devices, research has been conducted so as to make the devices more easily perform communication. In other words, a technique has been developed in which communication with other electronic devices is performed without causing a user of an electronic device to carry out laborious operations, such as setting of the address, ID, or the like of the communication partner.

For example, a technique has been proposed in which both communication devices perform communication with an information cue (for example, a shock wave generated when terminals are hit by each other, or the like) relating to an event in the real world (for example, refer to Japanese Patent No. 4074998). In other words, both electronic devices share the event information relating to the shape and the generation time of the shock wave, and either electronic device is made to search the other device having the same event information, whereby communication between both electronic devices is started.

According to Japanese Patent No. 4074998, it is possible to perform communication between both electronic devices without, for example, inputting the address, the ID, and the like of the electronic device of the communication partner right in the front.

### SUMMARY

However, when communication as in the technique of, for example, Japanese Patent No. 4074998 is performed, the communication partner is not able to be authenticated.

For this reason, there is concern that, for example, highly confidential information accumulated in the electronic device of the user is read by the other electronic device.

It is therefore desirable for the present technology to enable communication and authentication of the communication partner with a simple operation.

In one illustrative embodiment, an information processing apparatus includes a proximity panel, a communication module and a controller. The proximity panel receives first gesture information. The first gesture information is received in response to a trajectory of movement on the proximity panel. The communication module receives second gesture information from a computing device. The controller determines whether the first gesture information and the second gesture information correspond to predetermined gesture information. In the event that the controller determines that the first gesture information and the second gesture information correspond to the predetermined gesture information, the controller causes predetermined data to be communicated with the computing device.

In another illustrative embodiment, a computer-readable medium includes code that, when executed by a processor, causes the processor to: receive first gesture information in response to a trajectory of movement on a proximity panel; receive second gesture information from a computing device; determine whether the first gesture information and the second gesture information correspond to predetermined gesture information; and in the event that the processor determines that the first gesture information and the second gesture information correspond to the predetermined gesture information, cause predetermined data to be communicated with the computing device.

In an additional illustrative embodiment, a computer-implemented method for execution by a processor includes steps of: receiving first gesture information in response to a trajectory of movement on a proximity panel; receiving second gesture information from a computing device; determining whether the first gesture information and the second gesture information correspond to predetermined gesture information; and in the event that the first gesture information and the second gesture information are determined to correspond to the predetermined gesture information, causing predetermined data to be communicated with the computing device.

### BRIEF DESCRIPTION OF THE DRAWINGS

FIG. 1 is a diagram showing an example of the appearance of an electronic device according to an embodiment of the present technology;

FIG. 2 is a block diagram showing an example of the internal configuration of the electronic device of FIG. 1;

FIG. 3 is a diagram illustrating an example of a gesture;

FIG. 4 is a diagram showing an example of another gesture;

FIG. 5 is a diagram illustrating an example in which each electronic device is made to automatically recognize each relative position according to the present technology;

FIG. 6 is a diagram showing an example of still another gesture;

FIG. 7 is a flowchart describing an example of a data transmission and reception preparation process;

FIG. 8 is a flowchart describing an example of a gesture recognition process;

FIG. 9 is a flowchart describing an example of a data transmission process; and

FIG. 10 is a block diagram showing a configuration example of a personal computer.

### DETAILED DESCRIPTION

Hereinafter, an embodiment of the present technology disclosed herein will be described with reference to the drawings.

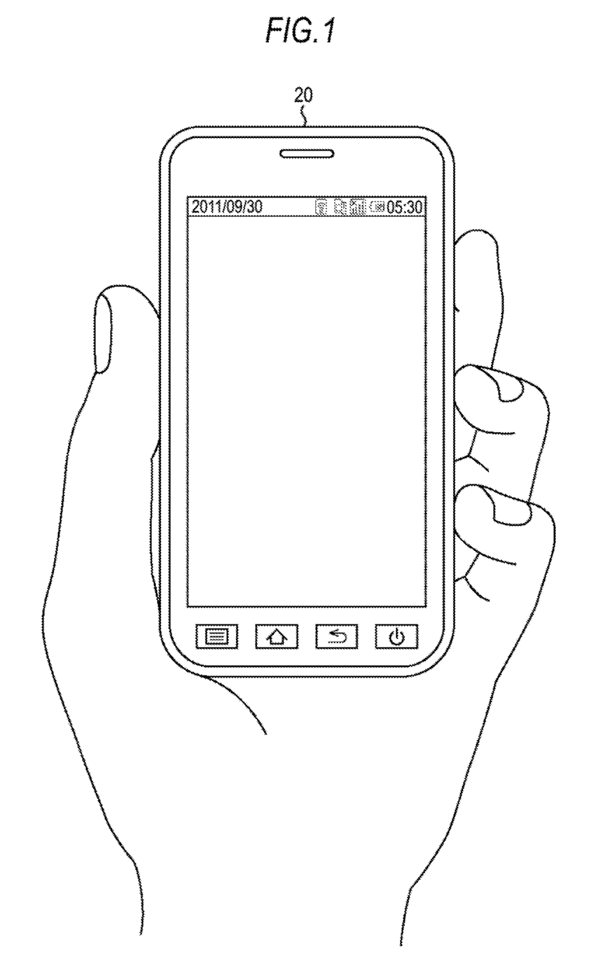

FIG. 1 is a diagram showing an example of the appearance of an electronic device according to an embodiment of the present technology. The electronic device 20 shown in the drawing is, for example, a small portable computer, and configured to be a so-called smartphone.

In this example, the electronic device 20 is configured as substantially a person's palm-sized electronic device, and includes a display formed of a touch panel. A user performs an input operation to the electronic device 20 by moving a finger on the display of the electronic device 20.

In addition, the electronic device 20 has a communication function to be described later, and can perform short range wireless communication with, for example, other electronic devices, a wireless LAN, and the like, or can access to a mobile communication network via a radio base station in the same manner as mobile telephones, and the like.

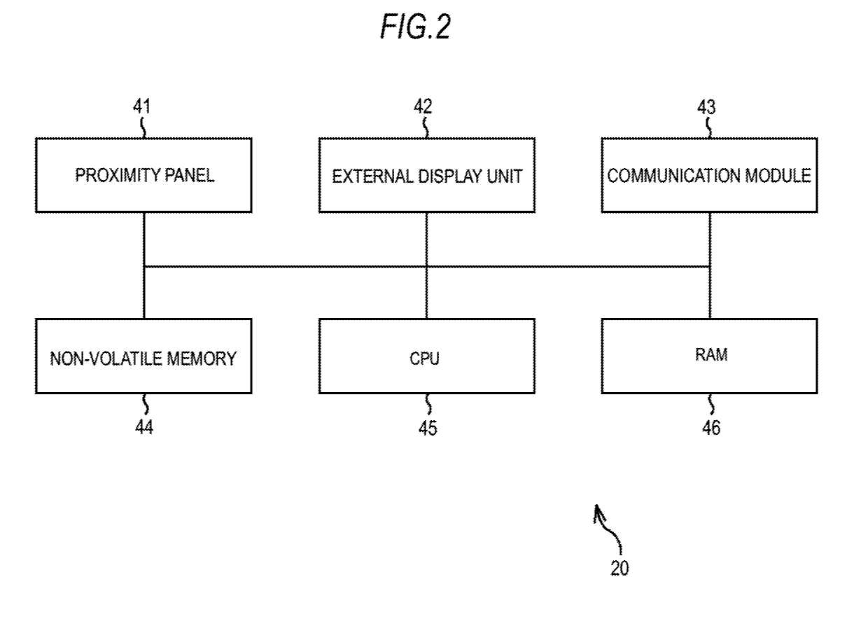

FIG. 2 is a block diagram showing an example of the internal configuration of the electronic device 20 of FIG. 1. As shown in the drawing, the electronic device 20 includes a proximity panel 41, an external display unit 42, a communication module 43, a non-volatile memory 44, a CPU 45, and a RAM 46, and the elements are connected to one another by a bus.

The proximity panel 41 detects, for example, changes in capacitance, and detects proximity of a finger of the user, and the like. When, for example, a finger of the user is proximate to the display of the electronic device 20, a change in capacitance at a predetermined position on the panel is detected, and at the position, a signal indicating how much the finger of the user, or the like is proximate is designed to be output.

Based on the signal output from the proximity panel 41, it is possible to set, for example, the display of the electronic device 20 to sense the proximity of the finger of the user, or the like (for example, proximate to a distance within 5 mm). In addition, based on the signal output from the proximity panel 41, it is also possible to sense that the finger of the user, or the like is proximate to the extent that the finger comes into contact with the display of the electronic device 20. In other words, the proximity panel 41 can sense both proximity and contact. Hereinbelow, sensing contact of a finger, or the like will be described as an embodiment of sensing proximity.

The external display unit 42 includes, for example, a liquid crystal display, and is designed to display predetermined images.

The display of the electronic device 20 is constituted by the proximity panel 41 and the external display unit 42. Thus, the display of the electronic device 20 can be used as a touch panel, and an image displayed on the display is operated as, for example, a GUI (Graphical User Interface).

The communication module 43 is constituted by, for example, a wireless communication unit for mobile communication network, and a short range wireless communication unit.

The wireless communication unit for mobile communication network performs wireless communication with a radio base station not shown in the drawing, and is a wireless communication device performing communication via a mobile communication network. The wireless communication unit for mobile communication network uses, for example, a frequency band of 2 GHz, and is used not only for a telephony application but also for various communication applications for internet access, and the like, using data communication with a maximum speed of 2 Mbps. Wireless communication by the wireless communication unit for mobile communication network is used in, for example, downloading of content data, and the like.

The short range wireless communication unit is a short range wireless communication device, for example, Bluetooth (a registered trademark, also referred to as BT), IEEE (Institute of Electrical and Electronic Engineers) 802.11x, or the like. Herein, short range wireless communication means local wireless communication (in a narrow area) with the maximum communicable distance of about several meters to dozens of meters. The communication standard is arbitrary. When, for example, the short range wireless communication unit performs BT communication, communication with a maximum speed of 3 Mbit/s (Bluetooth version 2.0+EDR and later) is performed in the band of 2.4 GHz via an antenna.

The non-volatile memory 44 is constituted by, for example, a semiconductor memory, or the like, and designed to store software such as a program executed by the CPU 45, downloaded content data, and the like. In addition, the data stored in the non-volatile memory 44 is designed to be supplied on the bus based on commands from the CPU 45.

The CPU (Central Processing Unit) 45 executes programs stored in the non-volatile memory 44 or various processes according to programs loaded on the RAM (Random Access Memory) 46. In addition, each part of the electronic device 20 is controlled by the CPU 45.

On the RAM 46, programs read from the non-volatile memory 44 are loaded, and data, and the like, necessary for the CPU 45 to execute various processes is also appropriately stored.

Next, mutual communication of the electronic device 20 will be described. The electronic device 20 can perform mutual communication based on short range wireless communication by the communication module 43. It is possible to transmit and receive data, and the like by short range wireless communication by a wireless LAN established between, for example, an electronic device 20-1 and another electronic device 20-2 placed adjacent to the electronic device 20-1.

For the electronic device 20, research has been conducted in order to enable the device to more easily perform communication. In other words, the user of the electronic device 20 can communicate with another electronic device 20 without carrying out a laborious operation, such as setting of the address, ID, or the like of the communication partner.

The electronic device 20-1 and the electronic device 20-2 can perform mutual communication in such a way that, for example, the electronic device 20-1 and the electronic device 20-2 that are desired for mutual communication are arranged side by side and just a finger is moved on the display of the electronic device 20-1 and the display of the electronic device 20-2.

Let us assume a case where, for example, the electronic device 20-1 and the electronic device 20-2 are arranged right and left, and the user moves his or her finger from left to right on each of the displays. In other words, the user has the finger close to one point on the display of the electronic device 20-1, and moves the finger to right onto the display of the electronic device 20-2. By doing this, immediately after the proximity panel 41 of the electronic device 20-1 does not sense the proximity of the finger, the proximity panel 41 of the electronic device 20-2 is supposed to sense the proximity of the finger.

At this moment, the time when the proximity panel 41 of the electronic device 20-1 senses the proximity of the finger and the time when the panel ends sensing of the proximity are stored in the non-volatile memory 44 of the electronic device 20-1 as event information. In addition, the time when the proximity panel 41 of the electronic device 20-2 senses the proximity of the finger and the time when the panel ends sensing of the proximity are stored in the non-volatile memory 44 of the electronic device 20-2 as event information.

In this case, the time when the proximity panel 41 of the electronic device 20-1 ends sensing the proximity of the finger and the time when the proximity panel 41 of the electronic device 20-2 senses the proximity of the finger are substantially the same (have sameness).

The CPU 45 of the electronic device 20-2, for example, reads the event information stored in the non-volatile memory 44 in the CPU and broadcasts the address, the ID of its own wireless LAN of the CPU together with the event information onto the wireless LAN. Accordingly, the event information transmitted from the electronic device 20-2 is acquired by the electronic device 20-1.

The CPU 45 of the electronic device 20-1 interprets the acquired event information, and specifies the time when the proximity panel 41 of the electronic device 20-2 senses the proximity of the finger (referred to as a sensing start time) and the time when the sensing of the proximity ends (referred to as a sensing end time). Then, the CPU 45 of the electronic device 20-1 reads its event information from the non-volatile memory 44, and specifies the sensing start time and the sensing end time of the electronic device 20-1.

Furthermore, the CPU 45 of the electronic device 20-1 compares both of the sensing start time and the sensing end time, and thereby specifying that the sensing end time of the electronic device 20-1 and the sensing start time of the electronic device 20-2 are substantially the same (when, for example, a difference between the respective times is within a predetermined threshold). Accordingly, the CPU 45 of the electronic device 20-1 determines that the electronic device 20-2 is its communication partner, and transmits predetermined information to the address of the wireless LAN that was received together with the event information sent from the electronic device 20-2. At this moment, the event information of the electronic device 20-1, the address and the ID of the wireless LAN, and the like are transmitted to the electronic device 20-2, and the electronic device 20-2 acquires the information.

Furthermore, even when still another electronic device being connected to the same wireless LAN acquires the event information broadcasted by the electronic device 20-2 on the wireless LAN, the device does not return the information since both of the sensing start times and the sensing end times are not substantially the same.

Then, the CPU 45 of the electronic device 20-2 interprets the acquired event information, and specifies that the sensing end time of the electronic device 20-1 and the sensing start time of the electronic device 20-2 are substantially the same. Accordingly, the CPU 45 of the electronic device 20-2 determines that the electronic device 20-1 is its communication partner, and transmits predetermined information to the address of the wireless LAN that was received together with the event information sent from electronic device 20-2.

Furthermore, even when event information is sent from still another electronic device being connected to the same wireless LAN to the electronic device 20-2, the electronic device 20-2 does not return the information since the sensing start times and the sensing end times of both devices are not substantially the same.

By doing this, mutual data exchange is performed by the electronic devices 20-1 and 20-2.

The above-mentioned example described a case where the sensing start time and the sensing end time are stored as event information. However, in this case, unless the times of the respective electronic devices on the wireless LAN are substantially completely synchronized with each other, it is not possible to correctly determine the communication partner.

For this reason, for example, the position (for example, a coordinate value) at the time when the proximity panel 41 of the electronic device 20-1 have sensed the proximity of the finger and the position at the time when sensing the proximity ends may set to be further stored on the non-volatile memory 44 of the electronic device 20-1 as event information. In addition, in this case, the position at the time when the proximity panel 41 of the electronic device 20-2 senses the proximity of the finger and the position at the time when sensing the proximity ends are stored on the non-volatile memory 44 of the electronic device 20-2 as event information.

In this way, by including information of positions in the event information, it is possible to determine the communication partner based on positions.

In this case, the position at the time when the proximity panel 41 of the electronic device 20-1 ends sensing the proximity of the finger is supposed to be any position at the left end portion of the display in the horizontal direction. In addition, the position at the time when the proximity panel 41 of the electronic device 20-2 senses the proximity of the finger is supposed to be any position at the right end portion of the display in the horizontal direction. In addition, the position in the vertical direction at the time when the proximity panel 41 of the electronic device 20-1 ends sensing the proximity of the finger is supposed to be substantially the same as the position in the vertical direction at the time when the proximity panel 41 of the electronic device 20-2 senses the proximity of the finger. This is because the proximity panel 41 of the electronic device 20-1 and the proximity panel 41 of the electronic device 20-2 detect the continuous movement of the finger.

In other words, the coordinate value (referred to as a sensing end coordinate value) corresponding to the position at the time when the proximity panel 41 of the electronic device 20-1 ends sensing the proximity of the finger and the coordinate value (referred to as a sensing start coordinate value) corresponding to the position at the time when the proximity panel 41 of the electronic device 20-2 senses the proximity of the finger are supposed to have the continuity as described above. This is because both of the coordinate values are detected based on the continuous movement of the finger by the user.

When the information relating to the positions is included in the event information, the electronic devices 20-1 and 20-2 perform mutual data exchange as follows.

For example, the CPU 45 of the electronic device 20-2 reads the event information stored in its non-volatile memory 44 and broadcasts the address, ID, and the like of its wireless LAN together with the event information onto the wireless LAN. Accordingly, the electronic device 20-1 acquires the event information sent from the electronic device 20-2.

The CPU 45 of the electronic device 20-1 interprets the acquired event information and specifies the sensing start coordinate value and the sensing end coordinate value of the electronic device 20-2. Then, the CPU 45 of the electronic device 20-1 reads its event information from the non-volatile memory 44 and specifies the sensing start coordinate value and the sensing end coordinate value of the electronic device 20-1.

Furthermore, the CPU 45 of the electronic device 20-1 compares the sensing start coordinate values and the sensing end coordinate values of both devices, and then specifies that the sensing end coordinate value of the electronic device 20-1 and the sensing start coordinate value of the electronic device 20-2 have continuity. Accordingly, the CPU 45 of the electronic device 20-1 determines that the electronic device 20-2 is its communication partner, and transmits predetermined information to the address of the wireless LAN received together with the event information sent from the electronic device 20-2. At this moment, for example, the event information, and the address and the ID of the wireless LAN of the electronic device 20-1, and the like are transmitted to the electronic device 20-2, and the electronic device 20-2 acquires the information.

Furthermore, even when still another electronic device being connected to the same wireless LAN acquires the event information broadcasted by the electronic device 20-2 on the wireless LAN, the device does not return the information since the sensing start coordinate values and the sensing end coordinate values of both devices do not have continuity.

In addition, the CPU 45 of the electronic device 20-2 interprets the acquired event information, and specifies that the sensing end coordinate value of the electronic device 20-1 and the sensing start coordinate value of the electronic device 20-2 have continuity. Accordingly, the CPU 45 of the electronic device 20-2 determines that the electronic device 20-1 is its communication partner, and transmits predetermined information to the address of the wireless LAN that was received together with the event information sent from the electronic device 20-2.

Furthermore, even when still another electronic device being connected to the same wireless LAN transmits event information to the electronic device 20-2, the electronic device 20-2 does not return the information since the sensing start coordinate values and the sensing end coordinate values of both devices do not have continuity.

In this way, the electronic device 20-1 and the electronic device 20-2 perform mutual data exchange. By doing this, even when, for example, time is not synchronized between the electronic device 20-1 and the electronic device 20-2, it is possible to perform mutual data exchange with a simple operation.

In addition, it may be possible to determine the communication partner by combining the sameness of the above-described sensing start time and the sensing end time and the continuity of the sensing start coordinate value and the sensing end coordinate value. When, for example, the sensing start time and the sensing end time have sameness and the sensing start coordinate value and the sensing end coordinate value have continuity, a device may be determined as the communication partner. Alternatively, only when the sensing start time and the sensing end time does not have sameness, a device may determine whether the other device is its communication partner or not based on determination of continuity of the sensing start coordinate value and the sensing end coordinate value.

In the above-described example, a case has been described in which the user has his or her finger move proximate to one point on the display of the electronic device 20-1 and moves the finger to right side onto the display of the electronic device 20-2. However, since the operation is very simple, there may be a case in which, for example, the user unintentionally conducts such operation. In order to avoid mutual data exchange caused by an erroneous operation, for example, a more complicated operation can be sought.

Mutual data exchange may be set to be fulfilled only by causing the finger to move back and forth twice or more between the displays of the electronic devices 20-1 and 20-2.

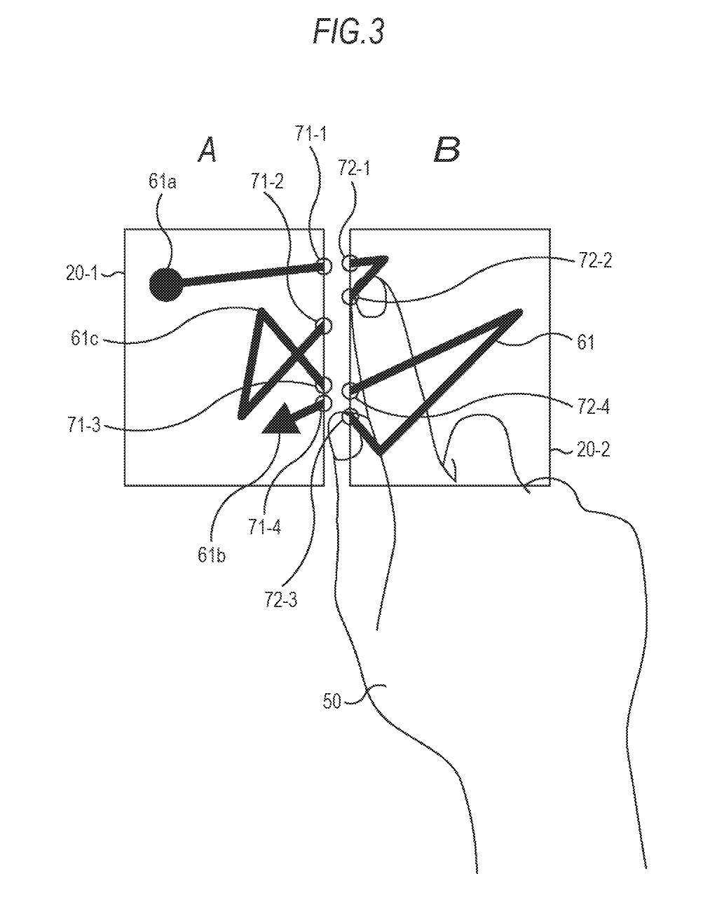

FIG. 3 is a diagram illustrating an example of a more complicated operation. In the example of the drawing, the electronic devices 20-1 and 20-2 are arranged side by side, and the display of the electronic device 20-1 is referred to as a display A and the display of the electronic device 20-2 is referred to as a display B in this example.

In addition, in FIG. 3, the trajectory of the tip of the index finger of the right hand 50 of the user is depicted as a trajectory 61. In the drawing, a round-shaped end part 61a is set to be the start point of the trajectory 61 and an arrow-shaped end part 61b is set to be the end point of the trajectory 61.

In other words, in the example of FIG. 3, after the user has the tip of the index finger of his or her right hand move proximate to the upper left part of the display A, the user shifts the finger to the right side and moves the finger tip near the upper right part of the display B. Then, the user shifts the finger to left as if turning back, and moves the finger tip to slightly upper right side of the display A. Moreover, making a movement with the finger as if drawing a triangle on the display A, the user moves the finger tip near the lower right part of the display B again. After that, making a movement with the finger as if drawing a triangle on the display B, the user moves the finger tip near the lower right part of the display A.

Furthermore, the trajectory 61 is drawn by moving the finger on the display A or the display B with the finger being proximate to the displays, and is a so-called one-stroke drawn trajectory. In other words, when the operation shown in FIG. 3 is performed, it is necessary for the user to move the finger tip as if the user draws a figure with one stroke on the displays A and B, and the series of movements of the finger tip of the user is recognized as an operation. The trajectory 61 may be displayed on the displays A and B, and may also be animated and provided in different colors based on a characteristic of the trajectory 61.

In this case, the coordinate values of the positions indicated by a circle 71-1 and a circle 72-1 in the drawing and the times corresponding to the positions can be included in event information. In addition, the coordinate values of the positions indicated by a circle 71-2 and a circle 72-2 in the drawing and the times corresponding to the positions can be included in event information. Furthermore, the coordinate values of the positions indicated by a circle 71-3 and a circle 72-3 in the drawing and the times corresponding to the positions can be included in event information. In addition, the coordinate values of the positions indicated by a circle 71-4 and a circle 72-4 in the drawing and the times corresponding to the positions can be included in event information.

In other words, the event information sent from the electronic device 20-1 includes the sensing end coordinate value or the sensing end time corresponding to each of the circles 71-1 and 71-3. At the same time, the event information sent from the electronic device 20-1 includes the sensing start coordinate value or the sensing start time corresponding to each of the circles 71-2 and 71-4.

Meanwhile, the event information sent from the electronic device 20-2 includes the sensing start coordinate value or the sensing start time corresponding to each of the circles 72-1 and 72-3. At the same time, the event information sent from the electronic device 20-2 includes the sensing end coordinate value or the sensing end time corresponding to each of the circles 72-2 and 72-4.

In the example of FIG. 3, the sensing start coordinate value and the sensing end coordinate value corresponding to the circle 72-1 and the circle 71-1, the sensing start coordinate value and the sensing end coordinate value corresponding to the circle 71-2 and the circle 72-2, the sensing start coordinate value and the sensing end coordinate value corresponding to the circle 72-3 and the circle 71-3, and the sensing start coordinate value and the sensing end coordinate value corresponding to the circle 71-4 and the circle 72-4 are supposed to have continuity.

Furthermore, since the trajectory 61 also includes slanting movements on the display A or the display B, a part of the trajectory 61 is indicated by an approximate straight line, and then the continuity of the sensing start coordinate value and the sensing end coordinate value is determined. For example, the CPU 45 of the electronic device 20-1 computes the approximate straight line indicating the line from the turning-back position 61c to the circle 71-3 on the display A, estimates the coordinate value of the circle 72-3 on the extension of the approximate straight line, and determines continuity of the sensing end coordinate value corresponding to the circle 71-3 and the sensing start coordinate value corresponding to the circle 72-3. The CPU 45 of the electronic device 20-2 also appropriately performs estimation in the same manner, and determines the continuity of the sensing end coordinate value and the sensing start coordinate value.

In this way, in the example of FIG. 3, the continuity of the sensing end coordinate value and the sensing start coordinate value is determined for the four pairs.

In addition, in the example of FIG. 3, the sensing start time and the sensing end time corresponding to the circle 72-1 and the circle 71-1, the sensing start time and the sensing end time corresponding to the circle 71-2 and the circle 72-2, the sensing start time and the sensing end time corresponding to the circle 72-3 and the circle 71-3, and the sensing start time and the sensing end time corresponding to the circle 71-4 and the circle 72-4 are supposed to have sameness.

In this way, in the example of FIG. 3, the sameness of the sensing end time and the sensing start time is determined for the four pairs.

As described above, the four pairs are determined to have continuity between the sensing end coordinate value and the sensing start coordinate value, and (or) the four pairs are determined to have sameness between the sensing end time and the sensing start time, the electronic devices 20-1 and 20-2 may be set to perform mutual data exchange. Alternatively, three out of the four pairs are determined to have continuity between the sensing end coordinate value and the sensing start coordinate value, and (or) sameness between the sensing end time and the sensing start time, the electronic devices 20-1 and 20-2 may be set to perform mutual data exchange.

By doing this, it may be possible to avoid, for example, unintentional mutual data exchange.

Furthermore, it may be also possible to have the types of data exchanged different according to, for example, the number of pairs determined to have continuity or sameness. For example, labels may be given to data processed by the electronic device 20-1 or the electronic device 20-2 in a unit of file.

The labels of files are changed according to, for example, the degree of confidentiality of the files. When, for example, a file labeled A is to be transmitted, the transmission is permitted only to a communication partner that is determined to have continuity between a sensing end coordinate value and a sensing start coordinate value and (or) sameness between a sensing end time and a sensing start time for one or more pairs. When a file labeled B is to be transmitted, the transmission is permitted only to a communication partner that is determined to have continuity between a sensing end coordinate value and a sensing start coordinate value and (or) sameness between a sensing end time and a sensing start time for two or more pairs.

Furthermore, such labels may set to be given to files, for example, classified based on a predetermined criterion, regardless of the degree of confidentiality. In addition, the labels may be given based on operations or setting by the user, or may be automatically given.

In this way, the types of exchanged data may be made to differ according to the number of pairs determined to have continuity or sameness. By doing this, it is possible to realize communication of which security is strengthened according to, for example, the complexity of the operation. In other words, in the embodiment of the present technology, communication can be performed by authenticating a communication partner corresponding to a predetermined operation. Therefore, according to the embodiment of the present technology, it is possible to perform communication with a simple operation and to authenticate a communication partner.

Hitherto, an example has been described in which communication is performed between two electronic devices, however, three or more electronic devices also can be set to perform mutual communication.

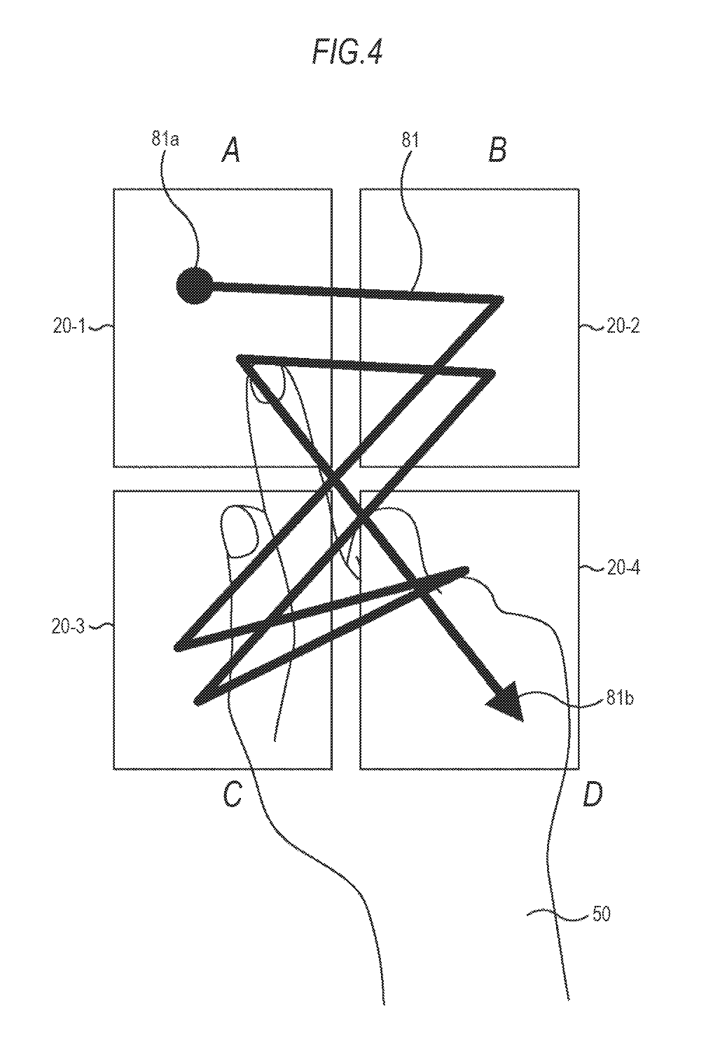

FIG. 4 is a diagram showing an example in which four electronic devices perform mutual communication. In the example of the drawing, the electronic devices 20-1 and 20-2 are arranged side by side, and below the devices, electronic devices 20-3 and 20-4 are arranged side by side. In this example, the displays of the electronic devices 20-1 to 20-4 are respectively referred to as a display A to a display D.

In addition, in FIG. 4, the trajectory of the tip of the index finger of the right hand 50 of the user is depicted as a trajectory 81. In the drawing, a round-shaped end part 81a is set to be the start point of the trajectory 81 and an arrow-shaped end part 81b is set to be the end point of the trajectory 81.

In the example of FIG. 4, the user moves the finger tip as if crossing over the display A and the display B, over the display B and the display C, and then over the display C and the display D. Furthermore, the user moves the finger tip as if crossing over the display C and the display B, over the display D and the display B, and over the display A and the display D.

Furthermore, the trajectory 81 is drawn by moving the finger on the display A to the display D with the finger being proximate to the displays, and is a so-called one-stroke drawn trajectory. In other words, when the operation shown in FIG. 4 is performed, it is necessary for the user to move the finger tip as if the user draws a figure with one stroke on the displays A to D, and the series of movements of the finger tip of the user is recognized as an operation.

According to the operation as above, the electronic devices 20-1 to 20-4 respectively exchange event information. In addition, in each of the electronic devices, the presence of continuity between a sensing end coordinate value and a sensing start coordinate value and (or) the presence of sameness between a sensing end time and a sensing start time are determined as described above, and the electronic devices 20-1 to 20-4 perform mutual data exchange.

In this way, according to the embodiment of the present technology, three or more electronic devices can perform mutual data exchange with one operation.

In addition, when the operation as shown in FIG. 4 is performed, it is possible to make the electronic devices 20-1 to 20-4 automatically recognize respective relative positions.

In other words, based on continuity between the sensing end coordinate value and the sensing start coordinate value on the trajectory 81, the electronic device 20-1 can specify the electronic device 20-2 to be positioned in the right side thereof, the electronic device 20-3 to be positioned in the lower side thereof, and the electronic device 20-4 to be positioned in the lower right side thereof. In the same manner, the electronic device 20-2 can specify which direction each of the electronic devices 20-1, 20-3, and 20-4 is positioned. The same manner is applied to the electronic devices 20-3 and 20-4. In this way, each electronic device can specify relative positional relationship between itself and other electronic devices.

Thus, when the operation as shown in FIG. 4 is performed, for example, each of the four electronic devices can automatically recognize each position of the rest of three electronic devices.

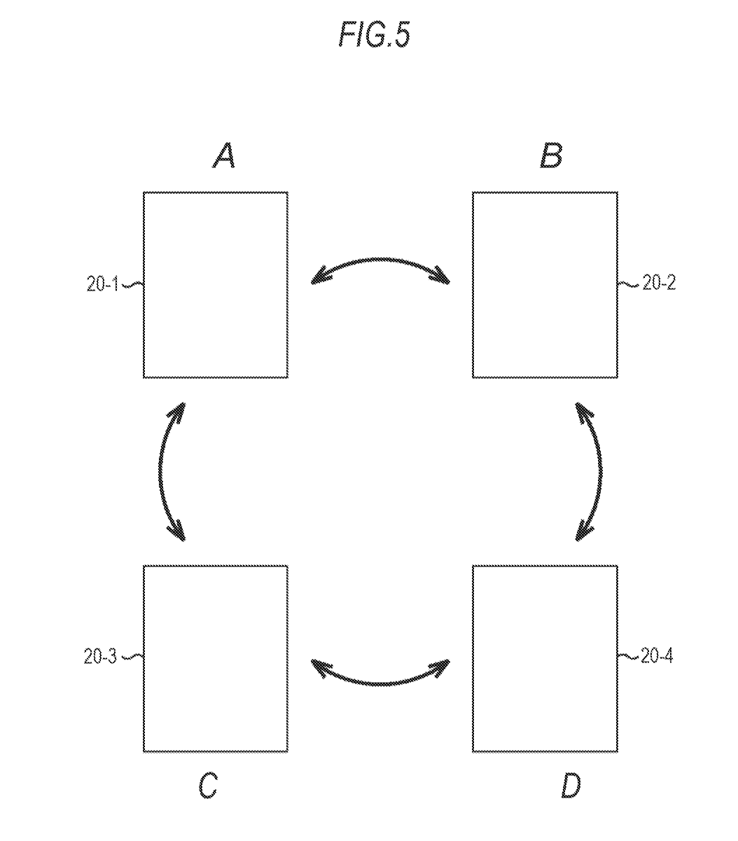

By doing this, it is possible to more simply execute a process, for example, a game, or the like played by using a plurality of electronic devices. When, for example, a card game, or the like is played using a plurality of electronic devices, it is possible to recognize a playing partner to whom a card is moved as shown in FIG. 5.

In the example of FIG. 5, the electronic devices 20-1 and 20-2 are arranged side by side, and below the devices, the electronic devices 20-3 and 20-4 are arranged side by side, without change. When, for example, the card game called Old Maid is played using the electronic devices 20-1 to 20-4, mutual exchange of cards between displays A to D can be displayed as indicated by the arrows in the drawing.

Hereinabove, the operation example has been described in which the finger tip is moved as if the finger tip crosses over the displays of the electronic devices mutually exchanging data. However, mutual data exchange between electronic devices may be set to be performed based on a different operation.

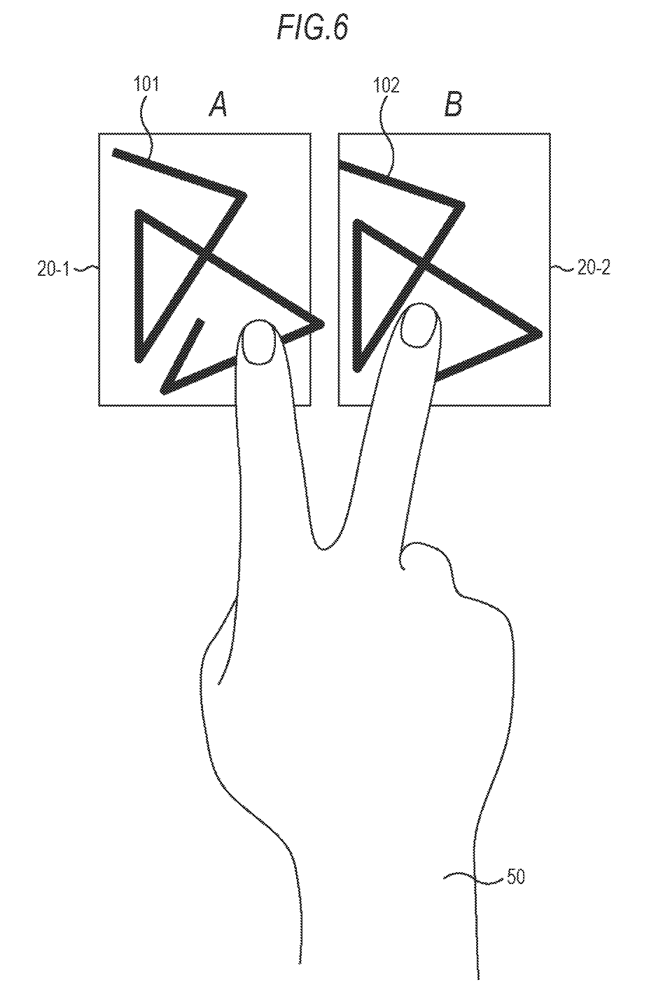

FIG. 6 is a diagram illustrating an example of an operation that is an operation for causing electronic devices to perform mutual data exchange and is different from the above-described example.

In the example of FIG. 6, the electronic devices 20-1 and 20-2 are arranged side by side, and the display of the electronic device 20-1 is referred to as a display A and the display of the electronic device 20-2 is referred to as a display B in this example.

In addition, in FIG. 6, the trajectory of the tip of the index finger of the right hand 50 of the user is depicted as a trajectory 101, and the trajectory of the tip of the middle finger is depicted as a trajectory 102. In other words, the user performs an operation corresponding to the trajectories 101 and 102 with the index finger proximate onto the display A and at the same time, the middle finger proximate onto the display B.

The operation shown in FIG. 6 is performed, for example, by making the shape of the alphabet “V” with the index finger and the middle finger of the right hand 50 and moving the right hand in that state. In this case, since the tip of the index finger and the tip of the middle finger move in the same direction at the same time, the figure corresponding to the trajectory 101 and the figure corresponding to the trajectory 102 are supposed to be substantially the same.

In the case of FIG. 6, for example, the shape of the trajectory 101 obtained based on the coordinate value sensed by the proximity panel 41 of the electronic device 20-1 is stored in the non-volatile memory 44 as event information. In addition, the shape of the trajectory 102 obtained based on the coordinate value sensed by the proximity panel 41 of the electronic device 20-2 is stored in the non-volatile memory 44 as event information.

In this case, for example, the CPU 45 of the electronic device 20-2 reads the event information from its non-volatile memory 44, and broadcasts the address, the ID, and the like of its wireless LAN together with the event information onto the wireless LAN. Accordingly, the electronic device 20-1 acquires the event information sent from the electronic device 20-2.

The CPU 45 of the electronic device 20-1 interprets the acquired event information, and specifies the shape of the trajectory 101 (referred to as a trajectory figure) obtained based on the coordinate value sensed by the proximity panel 41 of the electronic device 20-2. Then, the CPU 45 of the electronic device 20-1 reads its own event information from the non-volatile memory 44, and specifies the trajectory figure of the electronic device 20-1.

Furthermore, the CPU 45 of the electronic device 20-1 compares trajectory figures to specify that the trajectory figure of the electronic device 20-1 and the trajectory figure of the electronic device 20-2 are in the relation of similarity or congruence. Furthermore, at this moment, it is not necessary to precisely determine whether the relation is of similarity or congruence, however, it may be possible to specify that both trajectory figures are substantially in the relation of similarity or congruence by, for example, setting a certain level of threshold value.

Accordingly, the CPU 45 of the electronic device 20-1 determines that the electronic device 20-2 is its own communication partner, and transmits predetermined information to the address of the wireless LAN that was received together with the event information sent from the electronic device 20-2. At this moment, for example, the event information, and the address and the ID of the wireless LAN of the electronic device 20-1 are transmitted to the electronic device 20-2, and the electronic device 20-2 acquires the information.

Furthermore, even when still another electronic device being connected to the same wireless LAN acquires the event information that was broadcasted by the electronic device 20-2 on the wireless LAN, the another electronic device does not return the information since the trajectory figures of both devices are not in the relation of similarity or congruence.

Then, the CPU 45 of the electronic device 20-2 interprets the acquired event information and specifies that the trajectory figure of the electronic device 20-1 and the trajectory figure of the electronic device 20-2 are in the relation of similarity or congruence.

Furthermore, even when the another electronic deuce being connected to the same wireless LAN transmits the event information to the electronic device 20-2, the electronic device 20-2 does not reply the information since the trajectory figures of both devices are not in the relation of similarity or congruence.

In this way, the electronic devices 20-1 and 20-2 perform mutual data exchange.

In addition, when the operation shown in FIG. 6 is performed, in order to avoid performing mutual data exchange driven by, for example, an unintentional operation, a minimum value of the total extension of the trajectory may be set. When, for example, the total extension of the trajectory is less than 10 cm, it may be possible to set mutual data exchange not to be performed even when the trajectory figures of both devices are in the relation of similarity or congruence.

Furthermore, it may be possible to make the types of exchanged data differ according to, for example, the total extension value of the trajectory. For example, labels may be given to data processed by the electronic device 20-1 or the electronic device 20-2 in a unit of file.

The labels of files are changed according to, for example, the degree of confidentiality of the files. When, for example, a file labeled A is to be transmitted, the transmission is permitted only to a communication partner that is determined to have the total extension of the trajectory of 5 cm or longer, and the trajectory figures of both devices are in the relation of similarity or congruence. When a file labeled B is to be transmitted, the transmission is permitted only to a communication partner that is determined to have the total extension of the trajectory of 10 cm or longer, and the trajectory figures of both devices are in the relation of similarity or congruence.

As such, it may be possible to make the types of exchanged data differ according to the total extension value of the trajectory.

Alternatively, it may be possible to make the types of exchanged data differ according to the number of angles included in the trajectory, or the like. In short, it is enough to consider the degree of complexity of an operation.

In addition, hitherto, an example has been described in which the trajectory figures of both devices are compared to determine whether the figures are substantially in the relation of similarity or congruence, however, for example, the timings when the finger of the user comes into contact with the display may be compared. In this case, the time when the finger of the user comes into contact with the display is specified by the proximity panel 41, and the result is stored as event information.

For example, making the shape of the alphabet “V” with the index finger and the middle finger of the right hand 50, the user is made to move the right hand in that state and to perform a motion of simultaneously tapping the displays A and B with the finger tips. The finger tips are made to simultaneously tap plural times on the displays A and B, for example, to the rhythm of the user's favorite music. In this case, the contact times of the finger detected by both electronic devices are supposed to be the same.

With this configuration, even when the time is not completely synchronized between the electronic devices 20-1 and 20-2, for example, it is possible to determine sameness of the contact times of the finger detected by both electronic devices by comparing the time interval of plural contact times. Then, it may be possible that, when the contact times of the finger detected by both electronic devices are determined to have sameness, the electronic device that sent the event information is recognized as the communication partner, and then data exchanged is performed between the electronic devices.

Hereinafter appropriately in the present specification, the series of motions such as the movement of the finger of the user performed in the state of being proximate to the display as shown in FIG. 3, 4, or 6 will be referred to as a gesture. For example, an electronic device is made to operate in a gesture standby mode, and then, a motion performed by a user with a finger proximate to the device within a predetermined time is recognized as a gesture.

In addition, the above-described examples describe examples of gestures made by having the finger proximate to the display of the electronic device and moving, however, it may be possible to perform data exchange between electronic devices with a gesture made by having, for example, a stylus pen, or the like proximate to the displays of the electronic devices and moving.

Alternatively, for example, it is also possible that a motion of tapping on the displays of the electronic devices with a finger, a stylus pen, or the like is recognized as a gesture.

In this way, in the embodiment of the present technology, it is possible to realize communication of which security is strengthened according to, for example, complexity of the gesture. In other words, in the embodiment of the present technology, communication can be performed by authenticating a communication partner corresponding to the predetermined gesture. Therefore, according to the embodiment of the present technology, communication is possible and the communication partner can be authenticated with a simple operation.

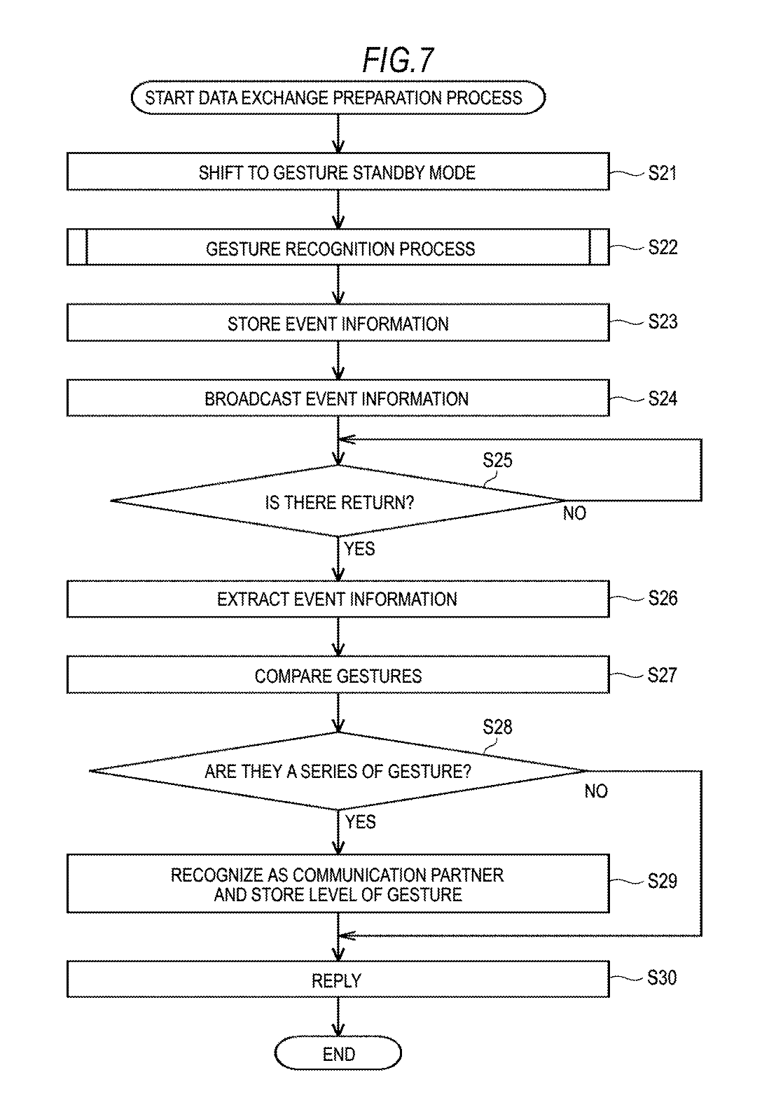

Next, with reference to the flowchart of FIG. 7, an example of a data exchange preparation process by an electronic device to which the present technology is applied will be described. The process is executed based on the operation of the user when, for example, data exchange is to be performed by two electronic devices 20.

In Step S21, the CPUs 45 of the electronic devices 20 shifts to the gesture standby mode.

When, for example, the user performs an operation determined beforehand such as selecting a component of a predetermined GUI displayed on the display, the electronic device 20 is set to shift to the gesture standby mode. If the device shifts to the gesture standby mode, then, a motion of the user made by, for example, having the finger proximate to the display within a predetermined time is recognized as a gesture.

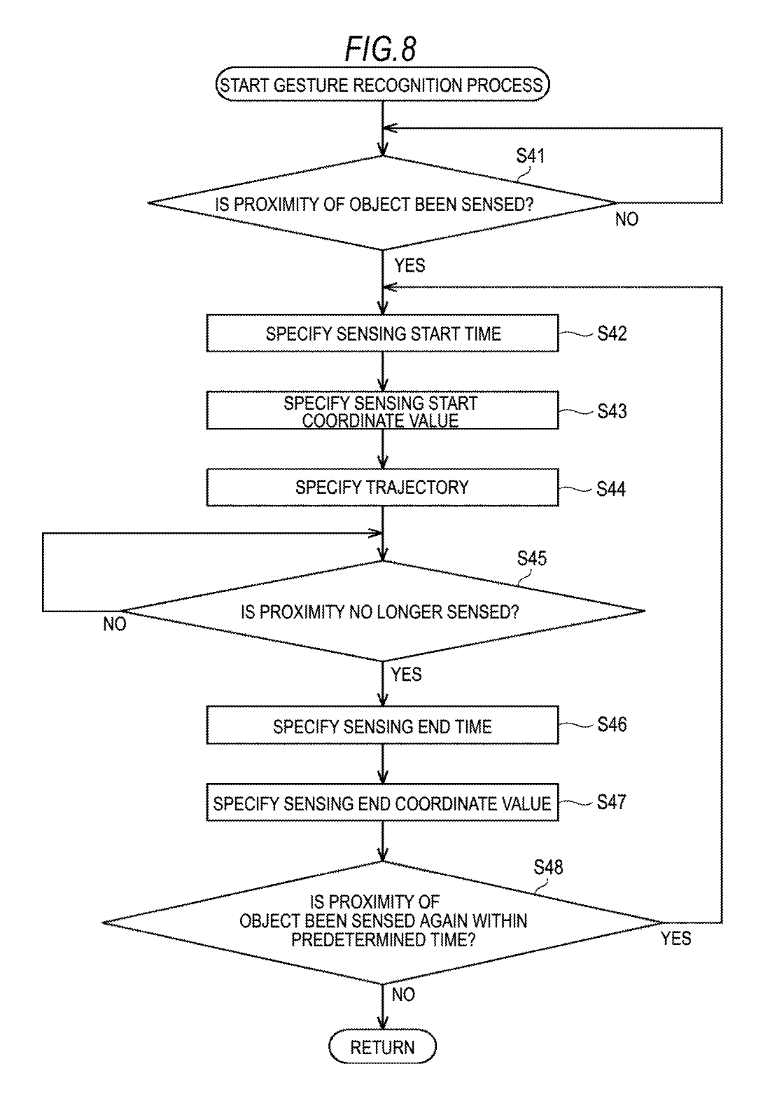

In Step S22, the CPU 45 executes a gesture recognition process to be described later with reference to FIG. 8. Accordingly, the motion of the user made by having the finger proximate to the display is recognized as a gesture.

In Step S23, the CPU 45 causes the non-volatile memory 44 to store event information corresponding to the gesture recognized in the process of Step S22. The event information stored herein is set to be event information relating to the gesture recognized by the device itself. As described above, information such as a sensing start time, a sensing end time, a sensing start coordinate value, a sensing end coordinate value, and a trajectory is stored as event information.

In Step S24, the CPU 45 broadcasts the event information stored in the process of Step S23. At this moment, the event information is broadcasted on, for example, the wireless LAN.

In Step S25, the CPU 45 determines whether there is a reply from another electronic device or not, and stands by until it determines that there is a reply. In Step S25, when it is determined that there is a reply from another electronic device, the process advances to Step S26.

In Step S26, the CPU 45 extracts event information included in the reply from another device. The event information extracted herein is set to be event information relating to a gesture recognized by another electronic device.

In Step S27, the CPU 45 compares the information included in the event information stored in the process of Step S23 to the information included in the event information extracted in the process of Step S26 to compare the gestures.

In Step S28, the CPU 45 determines whether the gesture recognized by itself and the gesture recognized by another electronic device are a series of gestures based on the comparison result from the process of Step S27.

At this moment, as described above with reference to FIG. 3, for example, sameness between the sensing start time and the sensing end time and (or) continuity between the sensing start coordinate value and the sensing end coordinate value are determined. In other words, the presence of sameness between the sensing start time and the sensing end time and (or) the presence of continuity between the sensing start coordinate value and the sensing end coordinate value are determined with regard to the gesture recognized by itself and the gesture recognized by another electronic device. Then, when it is determined to have sameness between the sensing start time and the sensing end time and (or) continuity between the sensing start coordinate value and the sensing end coordinate value, the gesture recognized by itself and the gesture recognized by another electronic device are determined to be a series of gestures.

Alternatively, as described with reference to FIG. 6, for example, it is determined whether trajectory figures of both devices are in the relation of similarity of congruence. Then, when the trajectory figures of both devices are determined to be in the relation of similarity or congruence, the gesture recognized by itself and the gesture recognized by another electronic device are determined to be a series of gestures.

In Step S28, when the gesture recognized by itself and the gesture recognized by another electronic device are determined to be a series of gestures, the process advances to Step S29.

In Step S29, the CPU 45 recognizes the another electronic device that is determined to have replied in the process of Step S25 as its communication partner, and stores the level of the gesture. The level of the gesture herein indicates the complexity of the gesture.

When, for example, the gesture that is determined to be the series of gestures in Step S28 has continuity between the sensing end coordinate value and the sensing start coordinate value and (or) sameness between the sensing end time and the sensing start time with respect to one or more pairs, a level 1 of the gesture is stored. In addition, when, for example, the gesture that is determined to be the series of gestures in Step S28 has continuity between the sensing end coordinate values and the sensing start coordinate values and (or) sameness between the sensing end times and the sensing start times with respect to two or more pairs, a level 2 of the gesture is stored.

Alternatively, when, for example, in the gesture that is determined to be a series of gestures in Step S28, the total extension of the trajectory is 5 cm or longer, a level 1 of the gesture is stored. In addition, when, for example, in the gesture that is determined to be a series of gestures in Step S28, the total extension of the trajectory is 10 cm or longer, a level 2 of the gesture is stored.

In this way, the complexity of the gesture in authenticating the communication partner is stored as a level of the gesture. In addition, at this moment, a level of the gesture is stored by being linked to the address, the ID, and the like of the communication partner.

In Step S30, the CPU 45 replies predetermined information to the electronic device recognized as the communication partner in the process of Step S29. At this moment, the predetermined information is transmitted to, for example, the address of the wireless LAN received together with the event information transmitted as a reply from the electronic device. For example, the address, the ID, and the like of its own wireless LAN are transmitted, and the other electronic device acquires the information.

In this way, the data exchange preparation process is executed.

Next, with reference to the flowchart of FIG. 8, a detailed example of the gesture recognition process of Step S22 of FIG. 7 will be described.

In Step S41, the CPU 45 determines whether proximity of an object is sensed or not, and stands by until proximity of an object is determined to be sensed. At this moment, it is determined whether an object is proximate to the display based on, for example, a signal output from the proximity panel 41.

In Step 41, when proximity of an object is determined to be sensed, and the process advances to Step S42.

In Step S42, the CPU 45 specifies the sensing start time.

In Step S43, the CPU 45 specifies the sensing start coordinate value.

In Step S44, the CPU 45 specifies the trajectory. At this moment, the trajectory of the movement of the object of which proximity is sensed is specified as a continuous coordinate value.

In Step S45, the CPU 45 determines whether the proximity is no longer sensed or still sensed, and stands by until the proximity is determined to be not sensed. For example, if the finger tip of the user moves from on the display A onto the display B in a gesture, the proximity of the object will not be sensed on the display A. In such a case, the proximity is determined to be not sensed in Step S45.

In Step S45, when the proximity is determined to be not sensed, the process advances to Step S46.

In Step S46, the CPU 45 specifies the sensing end time.

In Step S47, the CPU 45 specifies the sensing end coordinate value.

In Step S48, the CPU 45 determines whether proximity of the object has been sensed again within a predetermined time from when the proximity is determined to be not sensed in the process of Step S45. When, for example, the finger tip of the user moves from on the display A onto the display B and then moves from on the display B onto the display A in a gesture, proximity of the object is sensed again on the display A. In other words, if the user moves the finger tip back and forth between the display A and display B within a predetermined time, for example, it is determined that proximity of the object is sensed again within the predetermined time in Step S48.

When it is determined that the proximity of the object is sensed again within the predetermined time in Step S48, the process returns to Step S42, and the succeeding process is repeatedly performed.

On the other hand, when it is determined that the proximity of the object is not sensed again within the predetermined time in Step S48, the process ends.

In this way, the gesture recognition process is executed.

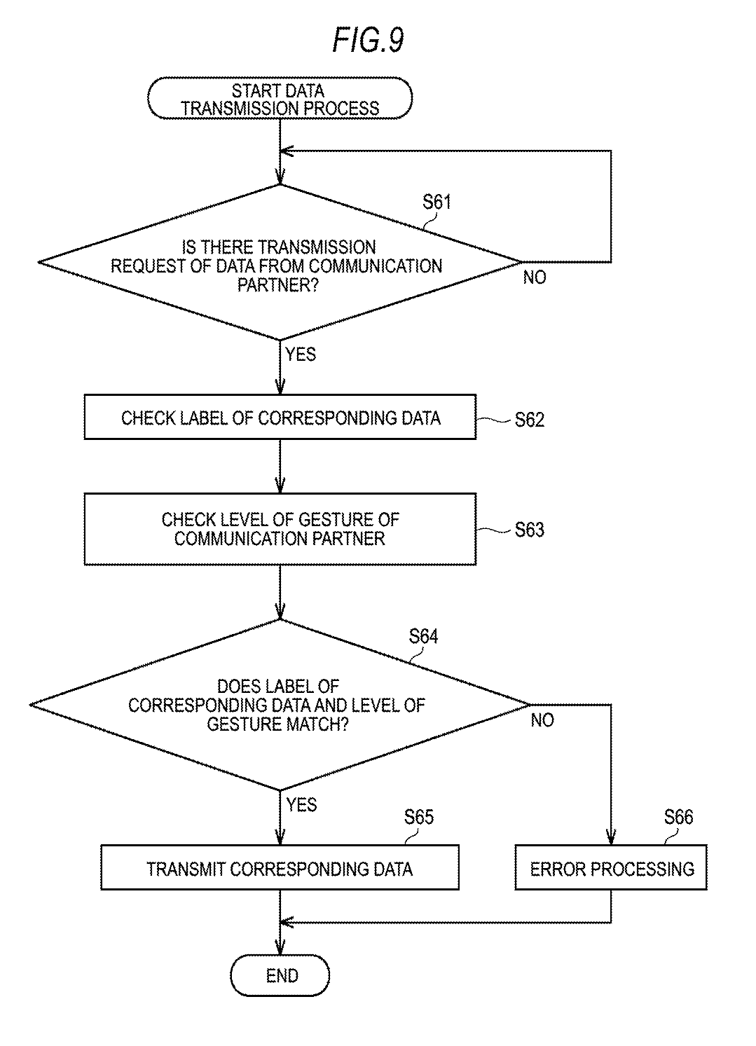

Next, with reference to the flowchart of FIG. 9, an example of a data transmission process executed in an electronic device to transmit data during a data exchange process between electronic devices performed as a result of the process of FIG. 7 is given.

In Step S61, the CPU 45 determines whether a data transmission request from the communication partner is made or not, and stands by until it is determined that a data transmission request is made.

In Step S61, when it is determined that a data transmission request is made, the process advances to Step S62.

In Step S62, the CPU 45 checks the label of data for which a transmission request is made (the corresponding data).

In Step S63, the CPU 45 checks the label of the gesture of the communication partner. At this moment, for example, the label of the gesture stored by being matched to the ID of the communication partner, or the like in the process of Step S29 of FIG. 7 is checked.

In Step S64, the CPU 45 determines whether the label of the data checked in the process of Step S62 is matched to the label of the gesture checked in the process of Step S63 or not.

As described above, in the embodiment of the present technology, it is possible to realize communication of which security is strengthened according to the complexity of a gesture.

When, as described above with reference to FIG. 3, for example, a file labeled A is to be transmitted, the transmission is permitted only to a communication partner that is determined to have continuity between the sensing end coordinate value and the sensing start coordinate value and (or) sameness between the sensing end time and the sensing start time with respect to one or more pairs. When a file labeled B is to be transmitted, the transmission is permitted only to communication partners that is determined to have continuity between the sensing end coordinate value and the sensing start coordinate value and (or) sameness between the sensing end time and the sensing start time with respect to two or more pairs.

In addition, as described above with respect to FIG. 6, for example, when a file labeled A is to be transmitted, the transmission is permitted only to a communication partner that is determined to have the total extension of the trajectory of 5 cm or longer and to have a trajectory figure in the relation of the similarity or congruence. When a file labeled B is to be transmitted, the transmission is permitted only to a communication partner that is determined to have the total extension of the trajectory of cm or longer and to have a trajectory figure in the relation of similarity or congruence.

In Step S64, as described above, it is determined whether communication partners recognize the gesture necessary for transmitting the corresponding data. In other words, when the label of the corresponding data corresponds to the label of the gesture, transmission of the corresponding data to communication partners is permitted.

In Step S64, when the label of the corresponding data is determined to correspond to the label of the gesture, the process advances to Step s65.

In Step S65, the CPU 45 transmits the corresponding data to the communication partner.

In this way, the data transmission process is executed.

Hereinabove, an example of a case in which electronic devices exchanging data have displays in the same shape and size has been described, however, it is not necessary for the electronic devices to have displays in the same size and shape.

In addition, hereinabove, an example in which an electronic device is configured to be a smartphone has been described, however, it is possible to configure the device as a mobile telephone, a personal computer, or the like. In addition, the present technology can be applied even to an electronic device in a larger size (for example, a size to the extent that a person is not able to carry out) as long as the device has a display configured to be a touch panel.

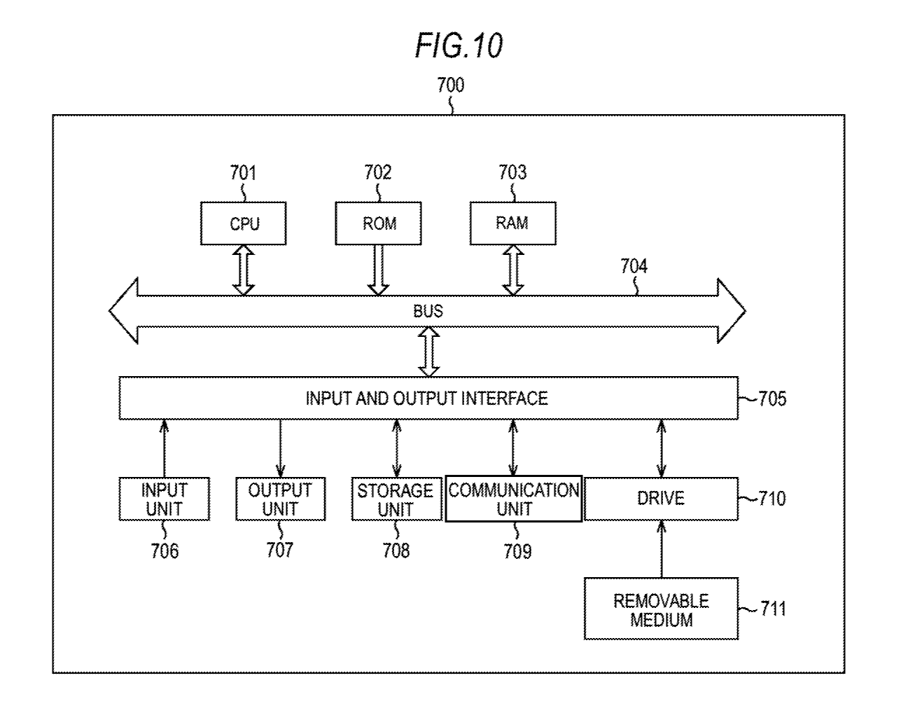

Furthermore, the series of processes described above can be executed by hardware or software. When the series of processes described above is executed by software, a program constituting the software is installed from a network or a recording medium in a computer incorporated into dedicated hardware or in a general-purpose personal computer 700 as shown in FIG. 10, for example, that can execute various functions by installing various programs.

In FIG. 10, a CPU (Central Processing Unit) 701 executes various processes according to a program stored in a ROM (Read Only Memory) 702, or a program loaded from a storage unit 708 to a RAM (Random Access Memory) 703. In addition, the RAM 703 appropriately stores data, and the like, necessary for the CPU 701 to execute various processes.

The CPU 701, the ROM 702, and the RAM 703 are connected to one another via a bus 704. In addition, the bus 704 is connected also to an input and output interface 705.

The input and output interface 705 is connected to an input unit 706 including a keyboard, a mouse, and the like, an output unit 707 including a display including an LCD (Liquid Crystal Display), a speaker, and the like, the storage unit 708 including a hard disk, and the like, and a communication unit 709 including a network interface such as a modem, a LAN card, and the like. The communication unit 709 performs a communication process via a network including the Internet.

In addition, the input and output interface 705 is connected to a drive 710 depending on necessity, and a removable medium 711 such as a magnetic disk, an optical disk, a magneto-optical disk, a semiconductor memory, or the like is appropriately mounted, and a computer program read therefrom is installed in the storage unit 708 depending on necessity.

When the series of processes described above is executed by software, a program constituting the software is installed from a network such as the Internet or a storage medium including the removable medium 711, or the like.

Furthermore, such a storage medium includes not only those configured to be the removable medium 711 including a magnetic disk (including a floppy disk (registered trademark)), an optical disk (including a CD-ROM (Compact Disk-Read Only Memory), and a DVD (Digital Versatile Disk)), a magneto-optical disk (including an MD (Mini-Disc) (registered trademark)), a semiconductor memory, or the like that is recorded with a program and distributed for delivering the program to a user separate from the main body of a device as shown in FIG. 10 but also those configured to be a hard disk included in the ROM 702 or a storage unit 708 that is recorded with such a program and delivered to the user in a state of being incorporated into the main body of the device.

Furthermore, the series of processes described above in the present specification includes processes performed in time series following the described order, and even though not necessarily including processes performed in time series, the series includes processes executed in parallel or individually.

In addition, embodiments of the present technology is not limited to the embodiment described above, and can be variously modified within the range not departing from the gist of the present technology.

Furthermore, the present technology may be implemented as the following configurations.

An information processing apparatus including: a proximity panel to receive first gesture information, wherein the first gesture information is received in response to a trajectory of movement on the proximity panel; a communication module to receive second gesture information from a computing device; and a controller to determine whether the first gesture information and the second gesture information correspond to predetermined gesture information, wherein, in the event that the controller determines that the first gesture information and the second gesture information correspond to the predetermined gesture information, the controller causes predetermined data to be communicated with the computing device.

The information processing apparatus of 1, wherein the predetermined gesture information corresponds to a plurality of locations proximate an edge of the proximity panel.

The information processing apparatus of 1, wherein the controller determines that the first gesture information and the second gesture information correspond to the predetermined gesture information when each of the first gesture information and the second gesture information individually and substantially match the predetermined gesture information.

The information processing apparatus of 1, wherein the controller determines that the first gesture information and the second gesture information correspond to the predetermined gesture information when a combination of the first gesture information and the second gesture information substantially matches the predetermined gesture information.

The information processing apparatus of 1, wherein the first gesture information and the second gesture information correspond to sequential time periods.

The information processing apparatus of 1, wherein the first gesture information and the second gesture information are spatially continuous.

The information processing apparatus of 1, wherein the first gesture information and the second gesture information correspond to essentially simultaneous time periods.

The information processing apparatus of 1, wherein the first gesture information and the second gesture information are provided as user input.

The information processing apparatus of 1, wherein the first gesture information corresponds to discontinuous input provided on the proximity panel.

The information processing apparatus of 1, wherein the first gesture information includes a plurality of first segments and the second gesture information includes a plurality of second segments.

The information processing apparatus of 10, wherein at least one of the second segments corresponds to a time period earlier than a time period to which at least one of the first segments corresponds.

The information processing apparatus of 1, wherein, in the event that the controller determines that the first gesture information and the second gesture information correspond to the predetermined gesture information, the computing device is authenticated to the information processing apparatus.

The information processing apparatus of 1, wherein the second gesture information is received from a plurality of mobile computing devices.

The information processing apparatus of 1, wherein the controller identifies one of: types of the predetermined data to communicate with the computing device and a mode of communicating the predetermined data with the computing device, the controller identifying the types or mode based on characteristics of at least one of the first gesture information and the second gesture information.

The information processing apparatus of 14, wherein the characteristics include a length of the corresponding gesture information.

The information processing apparatus of 14, wherein the characteristics include a complexity of the corresponding gesture information.

The information processing apparatus of 1, wherein the controller is configured to control display of the first gesture information on the proximity panel.

The information processing apparatus of 17, wherein the controller is configured to change a color of animation displayed on the proximity panel based on a characteristic of the first gesture information.

A computer-readable medium including code that, when executed by a processor, causes the processor to: receive first gesture information in response to a trajectory of movement on a proximity panel; receive second gesture information from a computing device; determine whether the first gesture information and the second gesture information correspond to predetermined gesture information; and in the event that the processor determines that the first gesture information and the second gesture information correspond to the predetermined gesture information, cause predetermined data to be communicated with the computing device.

A computer-implemented method for execution by a processor, the method including steps of: receiving first gesture information in response to a trajectory of movement on a proximity panel; receiving second gesture information from a computing device; determining whether the first gesture information and the second gesture information correspond to predetermined gesture information; and in the event that the first gesture information and the second gesture information are determined to correspond to the predetermined gesture information, causing predetermined data to be communicated with the computing device.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a proximity panel to receive first gesture information, wherein the first gesture information is received in response to a trajectory of movement on the proximity panel;
a communication module to receive second gesture information from a computing device; and
a controller to determine whether the first gesture information and the second gesture information correspond to predetermined gesture information,
wherein, in the event that the controller determines that the first gesture information and the second gesture information correspond to the predetermined gesture information, the controller causes predetermined data to be communicated with the computing device.

2. The information processing apparatus of claim 1, wherein the predetermined gesture information corresponds to a plurality of locations proximate an edge of the proximity panel.

3. The information processing apparatus of claim 1, wherein the controller determines that the first gesture information and the second gesture information correspond to the predetermined gesture information when each of the first gesture information and the second gesture information individually and substantially match the predetermined gesture information.

4. The information processing apparatus of claim 1, wherein the controller determines that the first gesture information and the second gesture information correspond to the predetermined gesture information when a combination of the first gesture information and the second gesture information substantially matches the predetermined gesture information.

5. The information processing apparatus of claim 1, wherein the first gesture information and the second gesture information correspond to sequential time periods.

6. The information processing apparatus of claim 1, wherein the first gesture information and the second gesture information are spatially continuous.

7. The information processing apparatus of claim 1, wherein the first gesture information and the second gesture information correspond to essentially simultaneous time periods.

8. The information processing apparatus of claim 1, wherein the first gesture information and the second gesture information are provided as user input.

9. The information processing apparatus of claim 1, wherein the first gesture information corresponds to discontinuous input provided on the proximity panel.

10. The information processing apparatus of claim 1, wherein the first gesture information comprises a plurality of first segments and the second gesture information comprises a plurality of second segments.

11. The information processing apparatus of claim 10, wherein at least one of the second segments corresponds to a time period earlier than a time period to which at least one of the first segments corresponds.

12. The information processing apparatus of claim 1, wherein, in the event that the controller determines that the first gesture information and the second gesture information correspond to the predetermined gesture information, the computing device is authenticated to the information processing apparatus.

13. The information processing apparatus of claim 1, wherein the second gesture information is received from a plurality of mobile computing devices.

14. The information processing apparatus of claim 1, wherein the controller identifies one of: types of the predetermined data to communicate with the computing device and a mode of communicating the predetermined data with the computing device, the controller identifying the types or mode based on characteristics of at least one of the first gesture information and the second gesture information.

15. The information processing apparatus of claim 14, wherein the characteristics comprise a length of the corresponding gesture information.

16. The information processing apparatus of claim 14, wherein the characteristics comprise a complexity of the corresponding gesture information.

17. The information processing apparatus of claim 1, wherein the controller is configured to control display of the first gesture information on the proximity panel.

18. The information processing apparatus of claim 17, wherein the controller is configured to change a color of animation displayed on the proximity panel based on a characteristic of the first gesture information.

19. A computer-readable medium comprising code that, when executed by a processor, causes the processor to:
receive first gesture information in response to a trajectory of movement on a proximity panel;
receive second gesture information from a computing device;
determine whether the first gesture information and the second gesture information correspond to predetermined gesture information; and
in the event that the processor determines that the first gesture information and the second gesture information correspond to the predetermined gesture information, cause predetermined data to be communicated with the computing device.

20. A computer-implemented method for execution by a processor, the method comprising steps of:
receiving first gesture information in response to a trajectory of movement on a proximity panel;
receiving second gesture information from a computing device;
determining whether the first gesture information and the second gesture information correspond to predetermined gesture information; and
in the event that the first gesture information and the second gesture information are determined to correspond to the predetermined gesture information, causing predetermined data to be communicated with the computing device.
